(19) United States
(12) Patent Application Publication
(10) Pub. No.: US 2015/0332239 A1
(43) Pub. Date: Nov. 19, 2015

(54) POINT OF SALE PLATFORM FOR CONSUMER MEDIA INTERACTION

(71) Applicant: MEI INC., Malvern, PA (US)

(72) Inventors: Thomas Anderson, Downingtown, PA (US); Bradford Reams Tedder, Atlanta, GA (US); Douglas Brian Haddon, Cinnaminson, NJ (US)

(21) Appl. No.: 14/652,408

(22) PCT Filed: Dec. 13, 2013
(86) PCT No.: PCT/US13/75077

§ 371 Date: Jun. 15, 2015

Related U.S. Application Data
(60) Provisional application No. 61/737,409, filed on Dec. 14, 2012.

(51) Int. Cl. G06Q 20/20; G06Q 20/18; H04L 29/08

(52) U.S. Cl. CPC G06Q 20/202; H04L 67/02; G06Q 20/18

(57) ABSTRACT

A point of sale system includes a host, an intermediate controller, a user interface device, and one or more peripheral devices. The intermediate controller includes an operating environment and is in communication with the host. The user interface device is associated with and in communication with the intermediate controller. The user interface includes a web browser and the intermediate controller includes a webserver, the webserver hosting one or more applications for interaction with a customer. The one or more peripheral devices are coupled to at least the intermediate controller via a bus. Related apparatus, systems, techniques, and articles are also described.

### RELATED APPLICATIONS

This application claims priority to U.S. Provisional Patent Application No. 61/737409 filed Dec. 14, 2012, the entire contents of which are hereby incorporated by reference herein.

### TECHNICAL FIELD

The subject matter described herein relates, in general, to electronic transaction systems and, in particular, to a dynamic consumer-interactive vending platform.

### BACKGROUND

Electronic transaction systems, such as vending machines, typically utilize Digital Exchange (DEX) and Multi-Drop Bus (MDB) protocols. A DEX file is an electronic audit file having information such as sales, cash in bill validators, pricing, etc. A vending machine controller (VMC) generally stores the information on a timely basis and transmits it in DEX format as a DEX file as and when requested. MDB can provide an interface between the vending machine and different peripheral devices, such as coin acceptors, bill acceptors, credit-card acceptors, etc. Additionally, the VMC can recognize and enable the peripheral devices for operation, after which the device and the VMC can communicate. The communication enables components of the system to work in concert to perform the functions of the vending machine, such as accepting payment, vending product, logging transactions, and transmitting transactional information to an external server.

However, conventional vending machines pre-configure to work with a specific set of peripheral devices and require replacement to support additional devices. Thus, the VMC is an integrated component that supports a specific set of functionalities and may require cost consuming replacements or extensions to offer additional functionalities. As an example, conventional VMC's only enable the following operations: receive a vending request; accept cash or credit to process the request; and process the vending request after receiving the intended amount. Furthermore, consumer interaction is limited to a static set of interface components, typically buttons. Prior attempts to expand vending machine functionality focuses on configuration changes with the VMC, thereby suggesting and requiring replacement of the VMC. However, replacing the VMC can be cost-prohibitive and undesirable.

### SUMMARY

In one aspect, a point of sale system includes a host, an intermediate controller, a user interface device, and one or more peripheral devices. The intermediate controller includes an operating environment and is in communication with the host. The user interface device is associated with and in communication with the intermediate controller. The one or more peripheral devices are coupled to at least the intermediate controller via a bus.

The intermediate controller can be an embedded personal computer control board. The intermediate controller operating environment can include an operating system and file system. The intermediate controller can receive data from a remote server. The user interface device and intermediate controller can be coupled via an Ethernet communication connection.

The intermediate controller can further include a telemetry module to configure alarms and notifications for instances such as door open, jammed item, temperature control, etc. The intermediate controller can further include one or more application modules, for example third party software applications. Further, at least one application module can be accessed by the user interface device. The application modules can support additional and enhanced functionalities. For example, the intermediate controller can include an application module, e.g. a web server module, to run a web browser on the user interface device. The user interface device thus hosts one or more applications for interaction with a customer. Furthermore, in one implementation, the web server module can be associated with a remoter server via a network (not shown). In this configuration, the web server module requests information pertaining to the customer, such as customer profiles, loyalty information, rewards, coupons, discounts, etc., and displays the information on the user interface device. The user can make further selections on the user interface module through the web browser, thus allowing the user to dynamically interact with the point of sale system. The web server can be HTTP compliant and the web server can be an HTTP application server.

In another example, the application module can include a multiple vend selection module, which supports the selections and vending of multiple items in a single transaction. In yet another example, the application module is a monitoring module configured to monitor and record details of the point of sale systems that request a specific application module. The application modules can also be associated with license numbers making it easier to track the updates and installations.

In one implementation, the application module can be a diet information module configured to store nutritional information for each of the vend items. Additionally or optionally, the diet information module may have access to the inventory and specific information on items. Further, the diet information module stores the selections made by the customer in each transaction with the nutritional information. The diet information module can provide suggestions and recommendations based on the customer purchasing history.

The point of sale system can further include a cashless bezel coupled to the intermediate controller. The intermediate controller can further include a cashless module for enabling cashless transactions. The bus, communicatively coupled with the intermediate controller and the host, can be a multi-drop data bus (MDB). Additionally, the peripheral devices can be communicatively coupled, directly or indirectly, to the host and the intermediate controller via the bus. The host can be a vending machine controller (VMC). The VMC can include a vending machine interface and one or more native button interfaces. Conventionally, the VMC is designed to be the master controller that controls all the peripheral devices through the bus. However, in one embodiment, the intermediate controller is assigned the peer role by controlling the application modules and/or peripheral devices and translating instructions into a language understood by the VMC. In another embodiment, the intermediate controller controls one or more peripheral devices through the bus, except the peripheral devices that are hardwired to the VMC. In this manner, the “master” role switches between the intermediate controller and the VMC based on the functionality.

In another aspect, a point of sale system includes a host, an intermediate controller, a user interface and one or more peripheral devices. The intermediate controller is in communication with the host and includes one or more third party applications utilizing an application interface to control components of the point of sale system according to predefined functions. The user interface device is associated with and in communication with the intermediate controller. The one or more peripheral devices are coupled to at least the intermediate controller via a bus.

In another aspect, a point of sale system includes an intermediate controller including an operating environment, a user interface device and one or more peripheral devices coupled to at least the intermediate controller via a bus. The user interface is associated with and in communication with the intermediate controller. The user interface includes a web browser and the intermediate controller includes a webserver, the webserver hosting one or more applications for interaction with a customer.

One or more of the following features can be included. For example, the components of the point of sale system can include one or more of mechanical, electrical, or software components. The components of the point of sale system can include one or more of the peripheral devices coupled to the intermediate controller. The components of the point of sale system can include the host. The components of the point of sale system can include the user interface device. A telemetry unit can be included and can be in communication with a remote licensing server. The user interface can include a web browser and the intermediate controller can include a webserver, the webserver hosting one or more of the third party applications for interaction with a customer. The one or more third party applications can have been installed on the point of sale system using a remote back end server to select the one or more third party applications for installation. The point of sale system can be in communication with a host remote from the point of sale system.

Computer program products are also described that comprise non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, a customer's purchasing history can be tracked and they can be rewarded according to pre-defined rules. Using the current subject matter, a customer can dynamically interact with the point of sale machine creating a unique and individualized consumer experience. The subject matter described herein can be implemented in existing point of sale machines in a cost-effective manner with minimal software and hardware modifications. In other words, the current subject matter enables an inexpensive retrofit of existing vending machines that does not require replacement of the VMC. Further, the current subject matter can integrate into existing machines and the capabilities are modular and can be expanded based upon need. This allows retrofit integration across many different and often disparate technologies, which many prior integrated solutions do not provide.

The current subject matter enables a point-of-sale machine to support advanced media functionality, for example social media interactivity, targeted advertisement, and personalized point-of-sale machine experience.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a system block diagram illustrating components of an example embodiment of a point of sale machine, including an intermediate controller;

FIG. 2 is a system block diagram illustrating components of another example embodiment of a point of sale machine, including intermediate controller;

FIG. 3 is a block diagram illustrating the layers of an example operating system in an exemplary intermediate controller environment;

FIG. 4 is a block diagram illustrating the application module controlling loyalty information of customers, according to an embodiment of the present subject matter; and

FIG. 5 is a block diagram illustrating the sharing of the bus between the intermediate controller and the VMC according to an embodiment of the present subject matter.

Like reference symbols in the various drawings indicate like elements.

### DETAILED DESCRIPTION

The current subject matter described herein supports additional functionalities to a point of sale system. In one implementation, the additional functionalities can be provided as a retrofit solution with little or no hardware modifications. Examples of point of sale systems include, but are not limited to, a vending machine, gaming machines, automated teller machines, banking machines, kiosks, bill pay machines, or any other host machine configured to accept payment in exchange for products and/or services. Such systems can dynamically interact with a variety of peripheral devices and provide additional functionalities. Additional functionalities include providing advertising, loyalty rewards, discounts, coupons, multiple vend items, social media interaction, mobile device or mobile wallet interaction, etc. Further, the point of sale machine can support dynamic engagement through a user interface, for example a touch screen. Existing point of service machines can be retrofit with the current subject matter, which will reduce cost associated with replacing an entire system. In addition, the device is configured to dynamically track and control software licenses and updates by interacting with a back end server or remote server or enterprise controller.

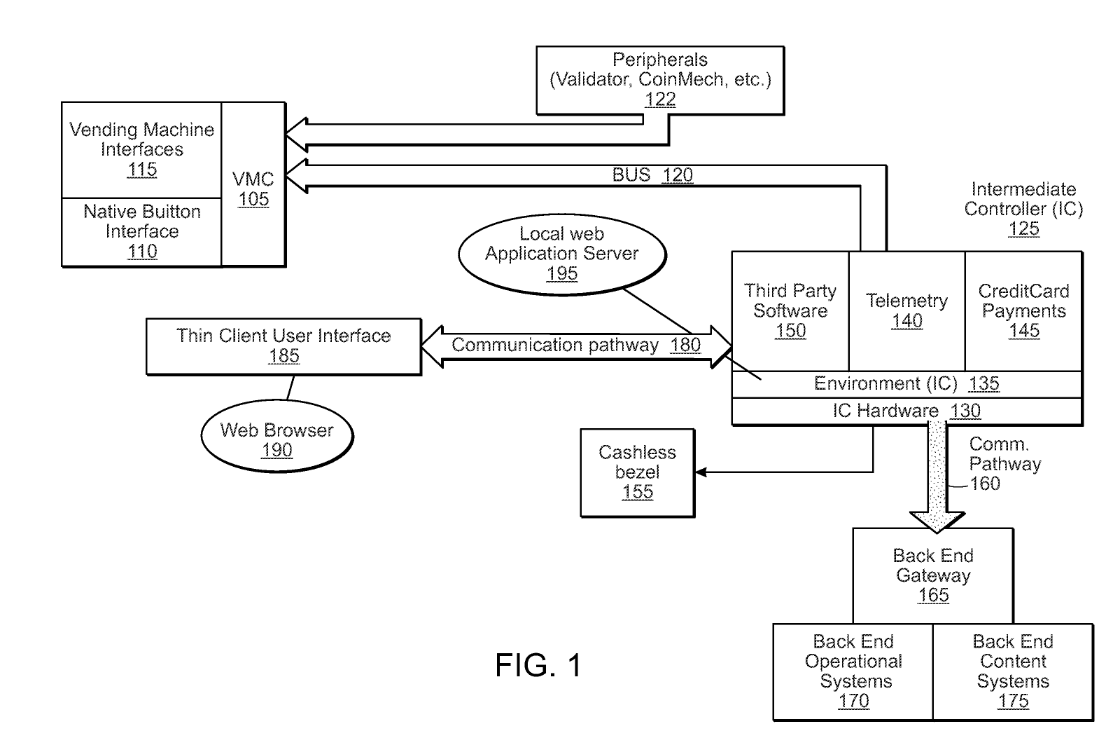

FIG. 1 is a block diagram illustrating components of an example embodiment of a point of sale system 100. In this embodiment, a VMC 105 is coupled to native button user interfaces 110 and other vending machine interfaces 115. The VMC 105 can connect via a bus 120 to a number of optional peripherals 125. The bus 120 can include an MDB bus or other suitable communications pathway such as Executive, BDV, micromech, cctalk, and Electromechanical. The optional peripherals 125 are peripherals that enable vending machine functionality. For example, a bill validator and coin validator are optional peripherals 122. Example bill validators and coin validators can include those described in, e.g., U.S. Pat. No. 6,390,269, the content of which is expressly incorporated by reference, in its entirety.

The VMC 105 also connects via bus 120 to an intermediate controller (IC) 125. The IC 125 is an embedded computing platform with unique hardware architecture and software framework that provides for flexible, expandable, and dynamic point of sale functionality. In one embodiment, the IC 125 is an embedded PC control board that provides multi-purpose hardware architecture, operating system, run time environments, with expandable hardware and software capability, and further includes industry standard interfaces. The IC 125 is connected via a communications pathway 180 to a thin client user interface 185. In one embodiment, the communications pathway 180 can be hardwired, such as an Ethernet, serial, USB, or similar connection. The thin client user interface 185 can be a standalone computing device that includes at least a graphical display that presents to a customer. The thin client interface 185 can include a display system that can function as a medium of consumer input (e.g., the display system can be an LCD touch screen). In general, the thin client user interface 185 provides access to applications running on the IC 125. In one embodiment, the thin client user interface 185 includes a web browser 190 that operates as a client in a client-server relationship with a web server 195 running on the IC environment 135 of the IC 125. Communication can occur between the thin client user interface 185 and the IC 125 through TCP/UDP protocol. In this embodiment, web server 195 is capable of serving graphics, media, video, audio and any other MIME type (i.e. standard content format under HTML standards) to the thin client user interface 185.

The IC 125 includes IC hardware 130 (e.g., an embedded PC control board) supporting an IC environment 135 (e.g., an operating system, file system, runtime environments, and other associated software applications). Optionally, the IC 125 can be powered via the bus 120. The IC 125 can also include a telemetry 140 module, a credit card payment 145 module, and third party software 150. The telemetry 140 module allows the point of sale machine to communicate with a back end or remote server, such as gateway 165. The telemetry 140 module provides for exchange of transactional and/or operational information (e.g., logging/audit, inventory information, etc.) between the point of sale machine and any backend services as well as deployment of software upgrades and additions to the point of sale machine. The telemetry 140 module can include dedicated communications hardware and associated software (e.g., for cellular, WiMax, WAN, LAN, etc.).

The credit card payment 145 module provides support for and controls a cashless bezel 155. The cashless bezel 155 is linked to the IC 125 and accepts credit card information through, e.g., magnetic swipe, contactless, chip card, IC Card, smartcard, EMV, and RFID tag interfaces. From the perspective of the VMC 105, the cashless bezel 155 is a cascaded peripheral that is controlled by the IC 125, but ultimately transactions that include the cashless bezel 155 will result in the IC 125 sending a credit message to the VMC to enable the transaction. The cashless bezel 155 can include those described in, e.g., U.S. Pat. No. 8,157,167, the contents of which is herein expressly incorporated by reference, in its entirety.

The IC 125 is connected via a communications pathway 160 (e.g., a wireless APN utilizing cellular technology or other suitable mode of communications) to a backend gateway 165. The backend gateway 165 includes backend operational systems 170 and backend content systems 175. In addition to supporting credit transaction, the back end gateway 165 can provide access for third parties to communicate with the point of sale machine (possibly to the third party software they have installed). In one example use, a customer can swipe a rewards or loyalty card and the IC 125 can communicate with a third party server to determine and/or receive information regarding the customer's loyalty account including any discounts, credits, or free purchases that the customer may be entitled to.

Additionally, the IC 125 may be allowed access to customer preferences and profiles stored on the third party server. The IC 125 then enables the thin client user interface 185 to support advanced media functionality, for example social media interactivity, targeted advertisement, personalization of a customer transaction experience, and e-commerce like customer experiences. In some embodiments, the thin client user interface 185 can be configured to display still images, stored video files, dynamic content and interactive content to a user. The current subject matter provides a rich consumer media and social networking experience. Further, the user may utilize multiple payment methods to make a purchase at the point of sale machine.

The IC 125, upon validating a coupon, rewards club benefit, or other discount, can send a message to the VMC 105 to add a credit for the benefit amount. Thus, from the VMC's 105 perspective, the IC 125 is another peripheral 122 such as a coin mechanism that is accepting payment from the customer and providing a credit notice to the VMC 105. Since the IC 125 can host third party software 150, the third party software 150 can instruct the IC 125 to send a credit message to the VMC 105 for a broad range of reasons, as desired by the third party software.

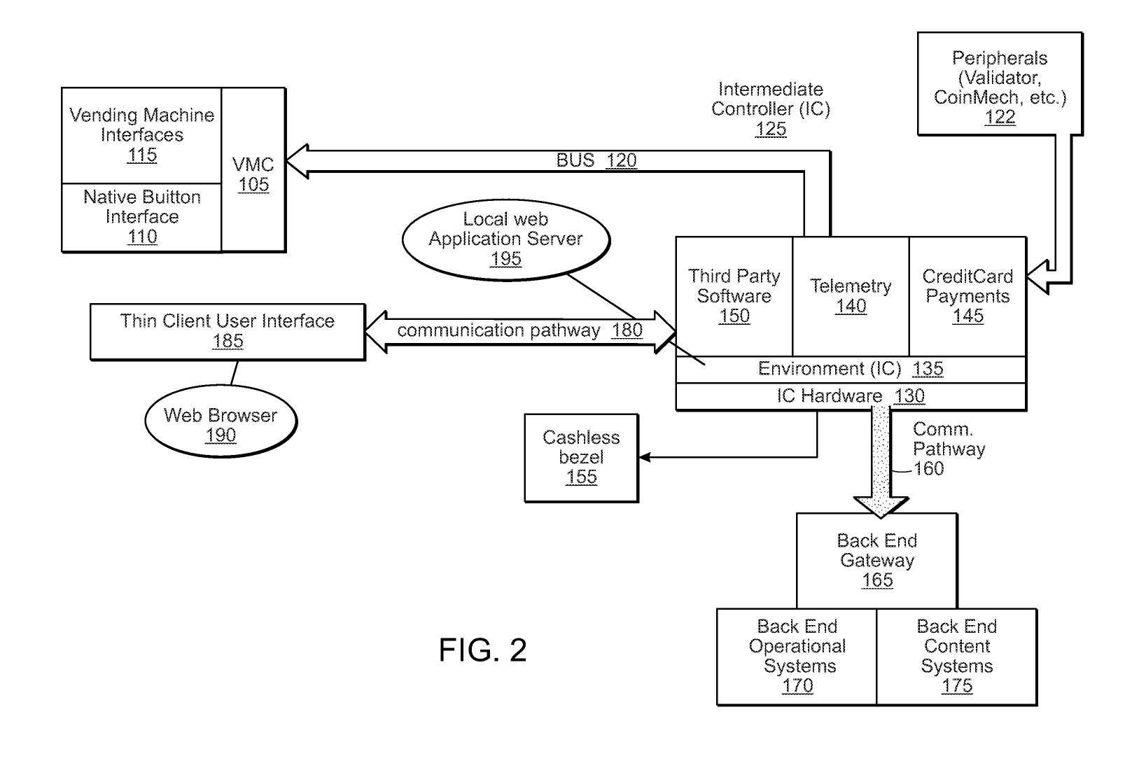

In one embodiment, the VMC 105 is designated as the master controller, which controls peripheral devices including optional peripherals 122 and IC 125 through the bus 120. However, in another embodiment as shown in FIG. 2, the optional peripherals 122 cascade from the IC 125. In this configuration, the IC 125 intercepts normal communication between the VMC 105 and optional peripherals 122 and acts as a master controller and instructs or tricks the VMC 105 with respect to newly defined functionalities; with the exception of vend requests. The IC 125 can “trick” the VMC into performing desired operations that the VMC is not designed to handle. For example, a customer could input a rewards club loyalty identification, coin, and bill value and the IC 125 could, in order to provide a discount, send the VMC 105 a message indicating a total credit input by the customer, even though the customer has not input sufficient funds (but in fact is receiving a discount). In this configuration, the VMC 105 continues to handle vend requests.

In another embodiment, with reference again to FIG. 1, the intermediate controller 125 acts as a peer to the VMC 105 rather than a master and peripheral configuration. In this embodiment, the IC 125 can query the VMC 105 and transmit a message that there is credit. In this case, the IC 125 translates the additional functionalities into vend requests, which can then be interpreted by the VMC 105 as legitimate requests with credit.

In another embodiment, the IC 125 and VMC 105 may work in a “shared environment,” that is, sharing functionalities. The VMC 105 can be configured to support at least a portion of newly defined functionalities. Thus, the “master” role is dynamic and switches between IC 125 and the VMC 105 based on a given functionality.

Functionalities supported include, but are not limited to: Multi Vend Selection (e.g. selection of multiple products or services within a single transaction), Discounts, Coupons, Advertisements, Recommendations/Suggestions based on customer profiling, Tracking and controlling software updates/licenses, other customer engagement. Examples of vending protocols include: Executive, MDB, BDV, Electromechanical.

Additionally or optionally, the gateway 165 may be associated with a monitoring module (not shown) within the IC 125. The gateway 165 interacts with a monitoring server designed to control the licenses downloaded on the point of sale machines coupled to the gateway 165. Such information is passed onto the monitoring module via the gateway 165. Thus, the monitoring module tracks software updates on the point of sale machines. This, in turn, helps in better management and handling of application modules stored on the point of sale machines.

The IC 125 provides for flexible expansion. For example, in one embodiment, a basic embedded computing platform can expand by adding to or improving the computing device (e.g., memory, hard drive, CPU, connectors, power supply, other third party removable component), onboard machine interfaces (e.g., USB 2.0, USB 3.0, MDB, EXEC, VCCS, Serial), expansion card (e.g., WAN Modem, CDMA, Ethernet, Bluetooth, Wifi, Memory Card, SD Card, Graphics Card, Secure Storage Card, Audio Card), software infrastructure (e.g., advanced data collection, distributed computing interfaces, VDI or other Data Exchange, VPN, DNS Utilization, Web/Application Server, Python, etc.), and any software application (e.g. a third party application).

Application Programming Interfaces (API) remove the need for point-of-sale machine specific designs thereby supporting and promoting development and use of third party applications that improve or control point-of-sale machine functionality. A standard interface (to mechanical, electrical, or software components of the point-of-sale machine) allows a third party (as distinguished from the original equipment manufacturer (OEM)) to create a third party application to utilize the point-of-sale machine (and, e.g., components thereof, including the IC 125, host, thin client user interface 185, and peripherals 122) according to pre-defined functions. For example, a web service interface that implements a device to server VDI standard can allow a third party to leverage the web service in developing a third party application.

For a given point-of-sale machine, a machine manager can access a defined set of available services and interfaces. This allows third party components (e.g., mechanical, electrical, and/or software) to operate within the boundaries of that point-of-sale machine. The effect is a flexible point-of-sale machine that a manager can tailor to a specific use (e.g., for selling a specific product, selling a product in a specific region or country, etc.). For example, a third party application can deploy on the IC 125 and operate alongside the telemetry 140 module to provide enhanced capabilities for tracking consumer purchasing behavior or enhanced advertisement capability.

Third party software distribution can be managed by a library of existing and available third party or OEM software components. A point-of-sale machine manager can view the application through, for example, a web application on the back end, and select the software that the manager would like installed on the point-of-sale machine. The point-of-sale machine can download an upgrade package from a backend server and install or update the software. Licensing and version control can be applied on a point-of-sale machine level, and point-of-sale managers are able to customize their machines.

Using the current subject matter, a customer can, for example, present a form of identification (e.g., credit card or loyalty club rewards card) to the point of sale machine. The point of sale machine can then remotely access a backend or remote server that includes information specific to that customer and download preferences, targeted advertisements, account information (e.g. point balances), and other individualized information and present the information to the customer via a display device. The information can be dynamic and does not need to be stored locally at the point of sale machine. The customer can interact with the dynamic information in order to complete a transaction. Such functionality of the point of service machine can be controlled, upgraded, changed, etc. through use of applications (third party or OEM). The functionality can be modified remotely, without having to install new hardware or have a technician service the machine.

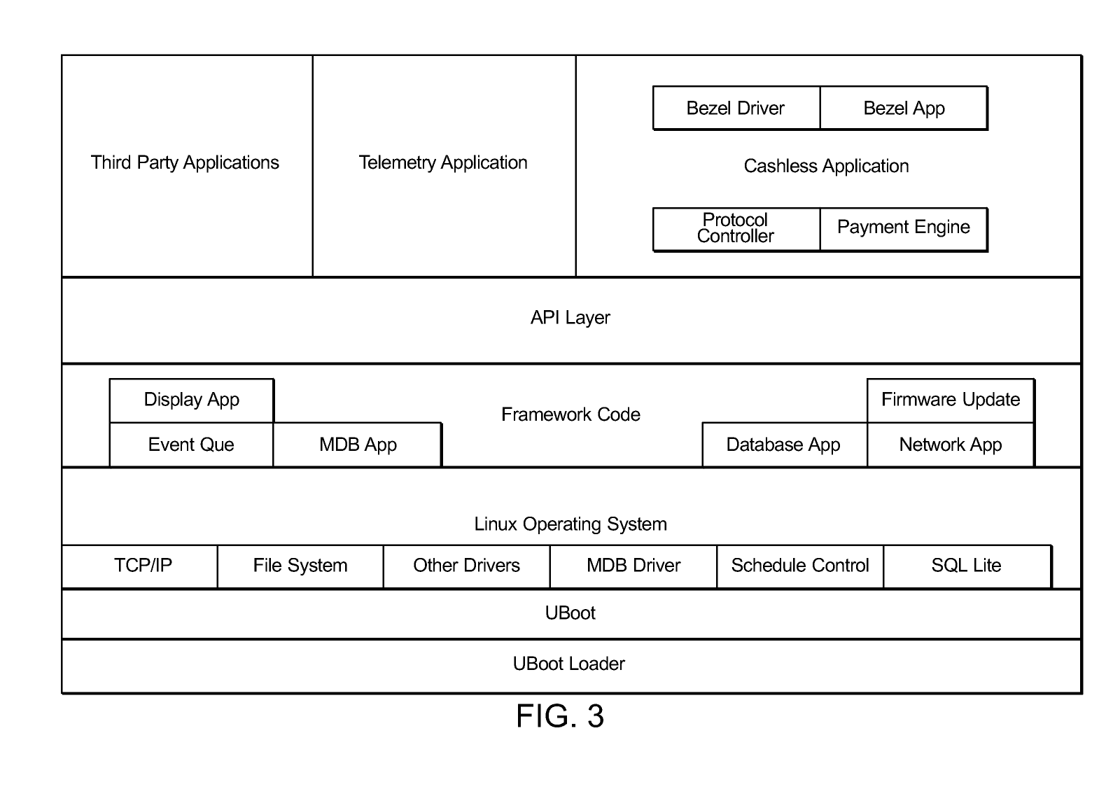

FIG. 3 is a block diagram illustrating the layers of an example operating system in an IC environment 135.

A point of service machine that includes an intermediate device 125 and thin user client 185 can present advertisements or other media. For example, the machine can be in an idle state and display one set of advertisements (e.g., static images or video). When a customer initiates a transaction, the machine can accept or determine identification of the customer. The IC 125 can then download targeted advertisement or other information for display by the thin client user interface 185.

The current subject matter can enable a point of sale machine, more specifically, a vending machine, to perform multiple vend operations using a single payment through say the multi product vend module (not shown). As an example, a customer can swipe a credit card. The IC 125 can validate the credit card for a predetermined amount (e.g., enough for three vends of product). The IC 125 can send three separate credit messages to the VMC 105 to enable a multi-vend procedure. For example, a customer swipes a credit card, authorization is performed, the VMC 105 is informed by the IC 125 that credit sufficient for a single product vend has been input, the customer selects the product using the native button interface 110, the VMC is again informed by the IC 125 that credit sufficient for a single product vend has been input (without additional customer input), and the customer can select the desired product using the native button interface 110. This process can be repeated for any number of vends (i.e., a multi-vend). Further, the MDB driver, shown in IC 125, allows the application modules to interact with the bus 120. In essence, the MDB driver acts as a translator between the application modules and the bus 120, ensuring that the protocol is followed. The IC 125 may also include a modem (not shown) to display content on external devices such as cellular phones via cellular network or any other network know in the art. Thus, in one implementation, a user may receive nutritional information or balance information on his cell phone.

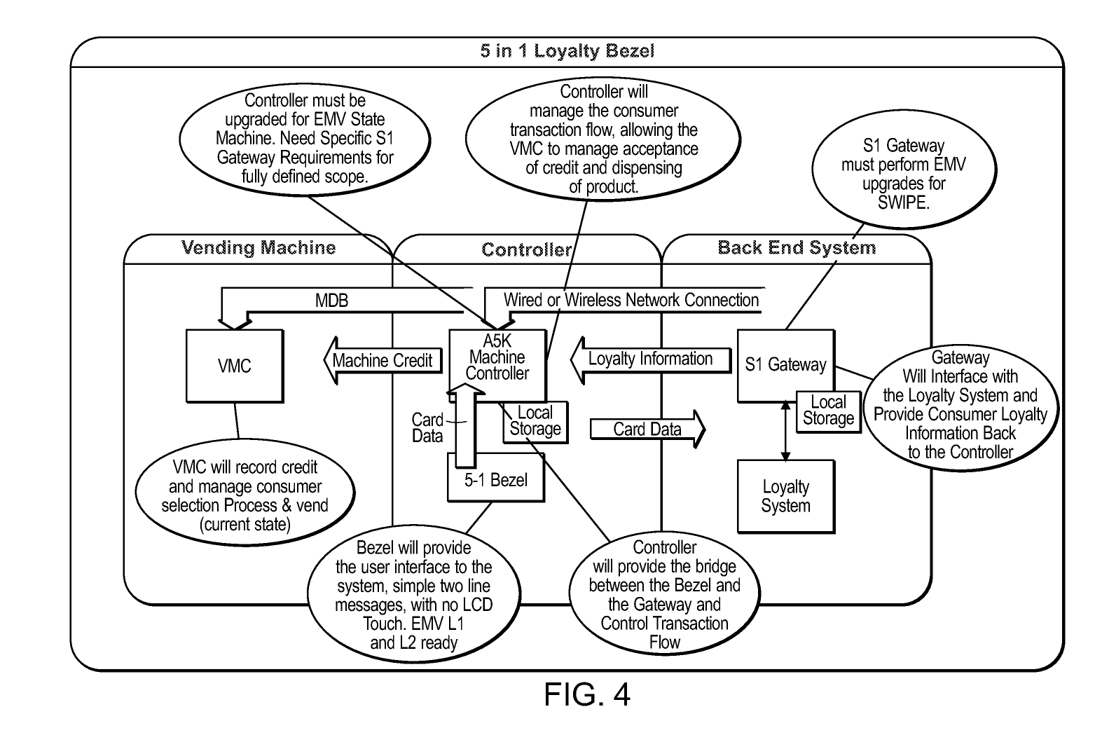

FIG. 4 is a block diagram illustrating the application module controlling loyalty information of customers, according to an embodiment of the present subject matter. Loyalty information can be stored on a loyalty system in the back-end system. A Si Gateway can interface with the loyalty system and provide consumer loyalty information to the controller. The controller can act as a bridge between the Bezel and the Gateway and can control a transaction.

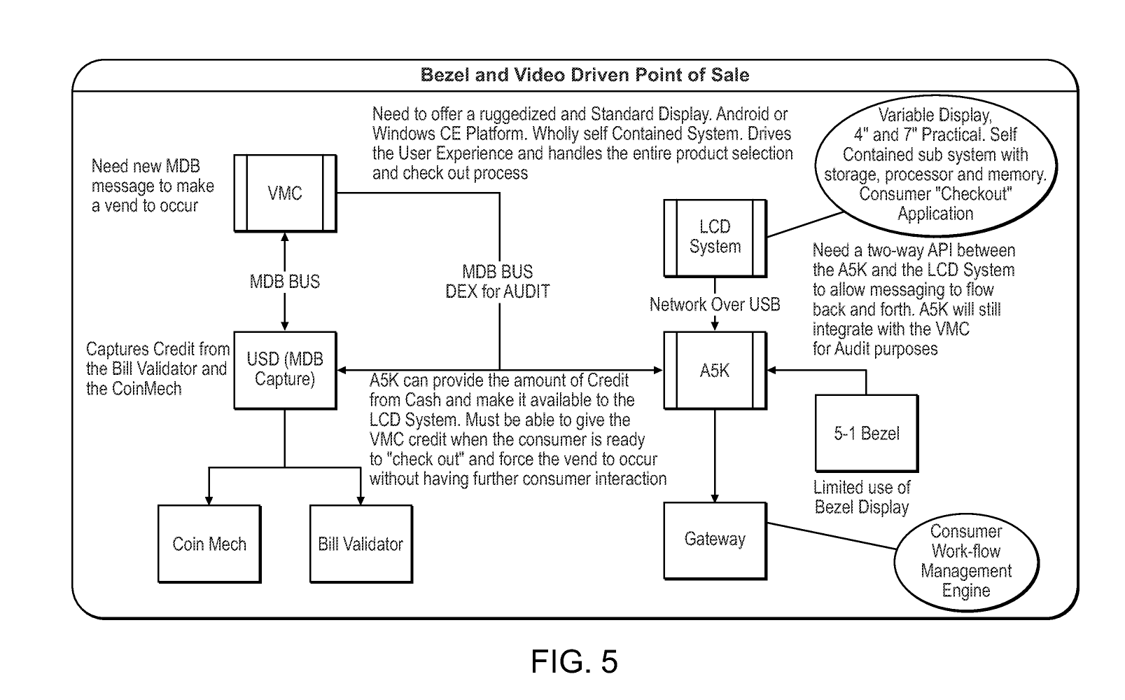

FIG. 5 is a block diagram illustrating the sharing of the bus between the intermediate controller and the VMC according to an embodiment of the present subject matter. The intermediate controller (or A5K) can provide credit amount from cash and the credit available to the thin client interface. When a consumer is ready to check out, the intermediate controller can cause a vend to occur without having further consumer interaction.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

1. A point of sale system comprising:
a host;
an intermediate controller including an operating environment and in communication with the host;
a user interface device associated with and in communication with the intermediate controller; and
one or more peripheral devices coupled to at least the intermediate controller via a bus.

2. The point of sale system of claim 1, wherein the user interface includes a web browser and the intermediate controller includes a webserver, the webserver hosting one or more applications for interaction with a customer.

3. The point of sale system of claim 2, wherein the web browser is HTTP and the webserver is an HTTP application server.

4. The point of sale system of claim 1, wherein the intermediate controller further includes a telemetry module.

5. The point of sale system of claim 1, wherein the intermediate controller further includes a cashless module.

6. The point of sale system of claim 1, wherein the intermediate controller further includes one or more third party software applications.

7. The point of sale system of claim 6, wherein the third party software applications are accessible by the user interface device.

8. The point of sale system of claim 1, wherein the bus is a multi-drop data bus (MDB).

9. The point of sale system of claim 1, wherein the peripheral devices are coupled to the host via the bus.

10. The point of sale system of claim 1, wherein the host is a vending machine controller (VMC).

11. The point of sale system of claim 10, wherein the VMC includes a vending machine interface and one or more native button interfaces.

12. The point of sale system of claim 1, further comprising a cashless bezel coupled to the intermediate controller, and wherein the intermediate controller further includes a cashless module configured to enable cashless transactions.

13. The point of sale system of claim 1, wherein the intermediate controller is an embedded personal computer control board.

14. The point of sale system of claim 1, wherein the intermediate controller operating environment includes an operating system and file system.

15. The point of sale system of claim 1, wherein the intermediate controller is configured to be powered by the bus.

16. The point of sale system of claim 1, wherein the intermediate controller is configured to receive data from a remote backend.

17. The point of sale system of claim 1, wherein the user interface device and intermediate controller are coupled via an Ethernet communication connection.

18. A method to retrofit a point of sale machine, the method comprising:
determining an identity of the point of sale machine, wherein the identity includes information of the point of sale machine;
based on the determination, receiving one or more application modules relevant to the point of sale machine; and
retrofitting an intermediate controller of the point of sale machine with the received one or more application modules; and
applying a driver to execute the one or more application modules.

19. A system, comprising:
a host;
a bus coupled to the host;
an intermediate controller coupled to the bus and the host, wherein the intermediate controller is configured to:
determine an identity of a point of sale machine, wherein the identity includes information of the point of sale machine;
based on the determination, receive one or more application modules relevant to the point of sale machine; and
retrofit the intermediate controller of the point of sale machine with the received one or more application modules; and
apply a driver to execute the one or more application modules.

20. A system comprising:
a host;
a bus coupled to the host;
an intermediate controller coupled to the bus and the host, wherein the intermediate controller comprises one or more application modules to provide one or more functionalities by translating instructions received from the one or more application modules into a host-understandable language.

21. The system of claim 20, wherein the one or more application modules include one or more of a web-server module, a diet information module, a loyalty server module, and a monitoring module.

22. The system of claim 20, wherein a switching unit is configured to switch a master ID between the host and the intermediate controller based at least on the one or more functionalities.
